(19) United States
(12) Patent Application Publication
(10) Pub. No.: US 2007/0120878 A1
(43) Pub. Date: May 31, 2007

(54) FLAT PANEL MONITOR INCLUDING A FRAME HAVING A PROTRUSION

(76) Inventors: Chih-Chun Hsiao, Kao-Hsiung Hsien (TW); Cheng-Min Liao, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,536

(22) Filed: Nov. 29, 2005

(51) Int. Cl. G09G 5/00

(52) U.S. Cl. 345/905; 345/156

(57) ABSTRACT

A flat panel monitor includes a first frame having an opening at a bend; a second frame having a protrusion corresponding to the opening, the protrusion being inserted into the opening for fixing the second frame to the first frame; and a display panel fixed on a housing formed by fixing the second frame to the first frame.

### BACKGROUND OF THE INVENTION

1. Field of the Invention

The present invention relates to a flat panel monitor, and more particularly, to a flat panel monitor including a frame having a protrusion.

2. Description of the Prior Art

A flat display monitor, such as a liquid crystal display monitor or a plasma display monitor, is a thinner and lighter monitor compared to a traditional cathode ray tube (CRT) monitor. Recently, as the related technology keeps improving, the manufacturing costs of flat display monitors are getting lower, so that flat display monitors are becoming much more popular for home use. For portability and convenience, laptop computers also use flat display monitors.

Please refer to FIG. 1 and FIG. 2. FIG. 1 shows a flat display monitor 100 of a laptop computer of the prior art. FIG. 2 is an exploded view of the flat display monitor 100 shown in FIG. 1. The flat display monitor 100 of the prior art comprises a metal frame 110, a plastic frame 120, and a display panel 130. The metal frame 110 and the plastic frame 120 are fixed together to form a housing 115 for accommodating the display panel 130. The flat display monitor 100 further comprises a backlight module 140 installed on the plastic frame 120 for providing light to the display panel 130. Because the metal frame 110 covers edges of a display surface of the display panel 130, the light from the backlight module 140 only penetrates through the display panel 130 without leaking from the edges of the metal frame 110.

Please refer to FIG. 3. FIG. 3 is a magnified localized view of the flat display monitor 100 shown in FIG. 1. In the prior art, the metal frame 110 and the plastic frame 120 are fixed together by screws 112. However, if too much torque is applied to a screw 112, the metal frame 110 becomes deformed and can even press on the display panel 130 resulting in light leakage. Moreover, in the assembly process, driving the screws 112 takes a lot of time and increases manufacturing cost.

### SUMMARY OF THE INVENTION

It is therefore an objective of the claimed invention to provide a flat panel monitor including a frame having a protrusion in order to solve the problems of the prior art.

The flat panel monitor of the present invention includes a metal frame having an opening at a bend; a plastic frame having a protrusion corresponding to the opening, the protrusion being inserted into the opening for fixing the plastic frame to the metal frame; and a display panel fixed on a housing formed by fixing the plastic frame to the metal frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a flat display monitor of a laptop computer of the prior art.

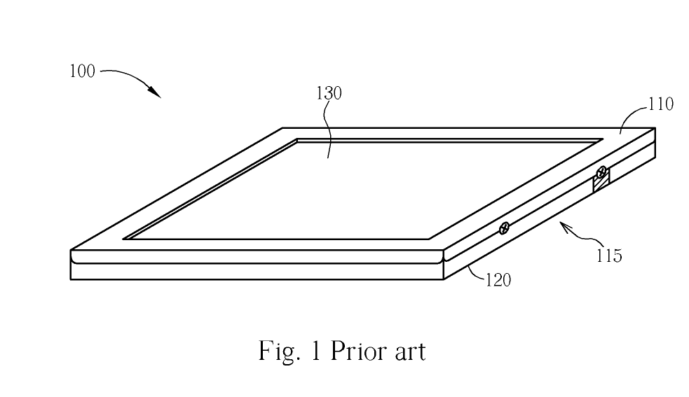

FIG. 2 is an exploded view of the flat display monitor shown in FIG. 1.

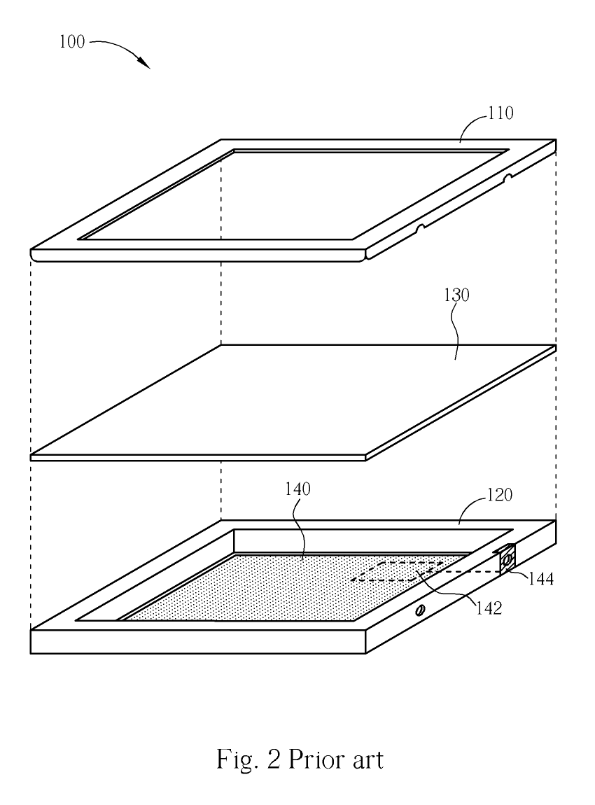

FIG. 3 is a magnified localized view of the flat display monitor shown in FIG. 1.

FIG. 4 is a diagram showing a flat display monitor of a laptop computer of the present invention.

FIG. 5 is an exploded view of the flat display monitor shown in FIG. 4.

FIG. 6 is a magnified localized view of the flat display monitor shown in FIG. 4.

FIG. 7 is a diagram showing another flat display monitor of a laptop computer of the present invention.

### DETAILED DESCRIPTION

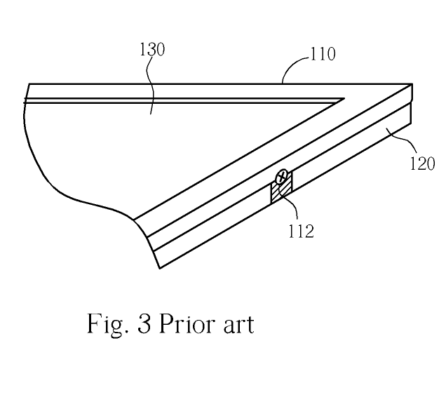

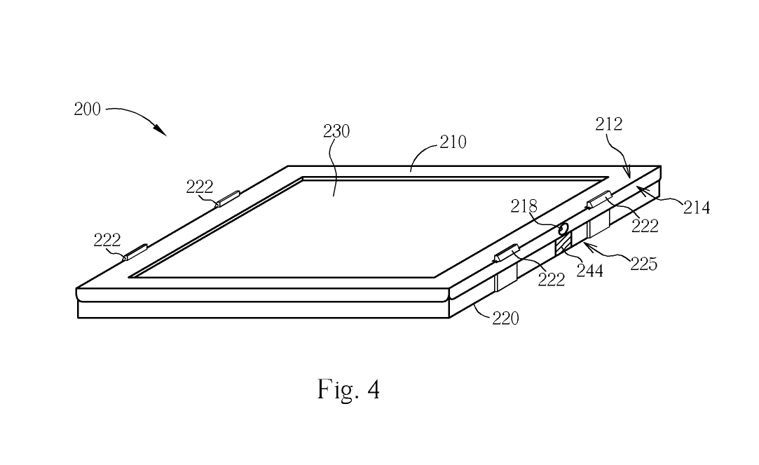

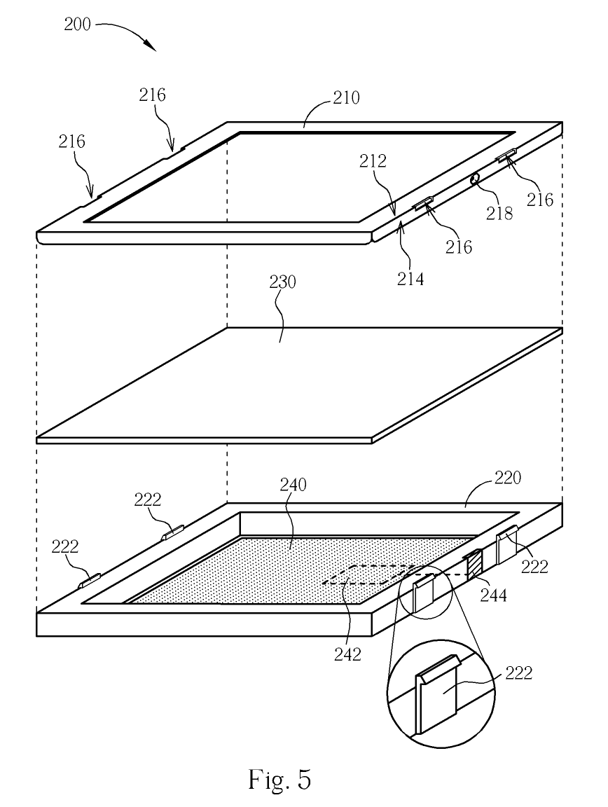

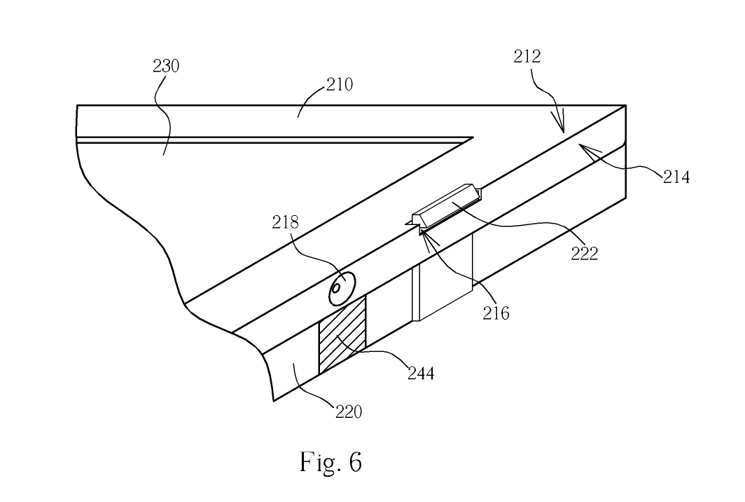

Please refer to FIG. 4 to FIG. 6. FIG. 4 shows a flat display monitor 200 of a laptop computer of the present invention. FIG. 5 is an exploded view of the flat display monitor 200 shown in FIG. 4. FIG. 3 is a magnified localized view of the flat display monitor 200 shown in FIG. 4. The flat display monitor 200 of the present invention comprises a metal frame 210, a plastic frame 220, a display panel 230, and a backlight module 240. The metal frame 210 and the plastic frame 220 are fixed together to form a housing 215 for accommodating the display panel 230. The backlight module 240 is installed on the plastic frame 220 for providing light to the display panel 230. The metal frame 210 has a plurality of openings 216 located at its bends, which are between the top plane 212 and the side plane 214. The plastic frame 220 has a plurality of protrusions 222 corresponding to the openings 216. The protrusion 222 are inserted into the openings 216 for fixing the plastic frame 220 to the metal frame 210. Because the openings 216 are located at the bends of the metal frame 210, it is very difficult to separate the protrusions 222 from the openings 216, even when pulling the lower edge of the side plane 214 outwards. In addition, because the metal frame 210 and the plastic frame 220 are fixed together without using screws, the metal frame 210 cannot be deformed to cause light leakage from too much torque applied to such screws. For fixing the metal frame 210 and the plastic frame 220 together, the operator only needs to press the metal frame 210 and the plastic frame 220 (around the openings 216 and the protrusions 222) to quickly assemble the flat panel monitor of the present invention.

In the prior art, the printed circuit board's 142 ground 144 of the backlight module 140 is electrically connected to the metal frame 110 via the screw 112 for grounding. In order to replace the screw, the metal frame 210 of the present invention further has a concave 218 for electrically connecting the printed circuit board's 242 ground 244 of the backlight module 240 to the metal frame 210. Generally, the metal frame 210 is a steel frame, and the plastic frame 220 is made by injection molding.

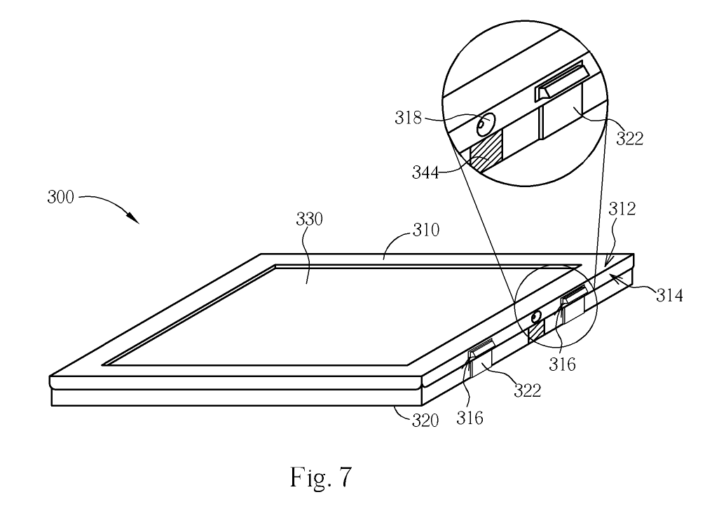

Please refer to FIG. 7. FIG. 7 shows another flat display monitor 300 of a laptop computer of the present invention. In the preferred embodiment of FIG. 4, the openings 216 are located at the bends of the metal frame 210, which are between the top plane 212 and the side plane 214. However, as shown in FIG. 7, the openings 316 can also be located at the side plane 314 of the metal frame 310, as long as fixing the plastic frame to the metal frame of the flat panel monitor by inserting the protrusion into the opening can be realized.

Summarizing the above, the present invention provides an easily assembled flat panel monitor 200, 300 of a laptop computer. The flat panel monitors 200, 300 of the present invention fix the metal frames 210, 310 and the plastic frames 220, 320 together by inserting the protrusions 222, 322 into the openings 216, 316 without using screws.

In contrast to the prior art, the flat panel monitors 200, 300 of the present invention can prevent light leakage caused by applying too much torque to screws. In addition, for fixing the metal frame 210, 310 and the plastic frame 220, 320 together, the operator can easily apply pressure around the openings 216, 316 of the metal frame 210, 310 and the protrusions 222, 322 of the plastic frame 220, 320 to quickly assemble the flat panel monitor 200, 300 of the present invention. This reduces the assembly time and manufacture cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A flat panel monitor comprising:
a first frame having an opening at a bend;
a second frame having a protrusion corresponding to the opening, the protrusion being inserted into the opening for fixing the second frame to the first frame; and
a display panel fixed on a housing formed by fixing the second frame to the first frame.

2. The flat panel monitor of claim 1 wherein the first frame further has a concave for electrically connecting to a circuit board.

3. The flat panel monitor of claim 1 wherein the first frame is a metal frame.

4. The flat panel monitor of claim 3 wherein the first frame is a steel frame.

5. The flat panel monitor of claim 1 wherein the second frame is a plastic frame.

6. The flat panel monitor of claim 5 wherein the second frame is made by injection molding.

7. The flat panel monitor of claim 1 further comprising a backlight module installed on the second frame.

8. The flat panel monitor of claim 1 being a monitor of a laptop computer.

9. A flat panel monitor comprising:
a first frame comprising a first plane and a second plane, the second plane having an opening;
a second frame having a protrusion corresponding to the opening, the protrusion being inserted into the opening for fixing the second frame to the first frame; and
a display panel fixed on a housing formed by fixing the second frame to the first frame.

10. The flat panel monitor of claim 9 wherein the first frame further has a concave for electrically connecting to a circuit board.

11. The flat panel monitor of claim 9 wherein the first frame is a metal frame.

12. The flat panel monitor of claim 11 wherein the first frame is a steel frame.

13. The flat panel monitor of claim 9 wherein the second frame is a plastic frame.

14. The flat panel monitor of claim 13 wherein the second frame is made by injection molding.

15. The flat panel monitor of claim 9 further comprising a backlight module installed on the second frame.

16. The flat panel monitor of claim 9 wherein the first plane of the first frame covers edges of a display surface of the display panel, and the second plane is perpendicular to the first plane.

17. The flat panel monitor of claim 9 being a monitor of a laptop computer.
